(19) United States
(12) Patent Application Publication
(10) Pub. No.: US 2006/0129713 A1
(43) Pub. Date: Jun. 15, 2006

(54) Pipeline architecture for content creation for the portable media player from the internet

(76) Inventor: Ian Zheng-Yi Xie, Redwood City, CA (US)

Correspondence Address: PATENT LAW GROUP LLP, 2635 NORTH FIRST STREET, SUITE 223, SAN JOSE, CA, 95134, US

(21) Appl. No.: 11/014,440

(22) Filed: Dec. 15, 2004

(51) Int. Cl. G06F 5/00

(52) U.S. Cl. 710/52

(57) ABSTRACT

A method for transferring a media file includes receiving the media file from a computer network and writing a first portion of the media file into a first buffer. When the first buffer is full, the method further includes writing a second portion of the media file into a second buffer, reading out the first portion from the first buffer, converting the first portion, and writing the first portion into a third buffer. When the second buffer is full and the first portion has been converted and written into the third buffer, the method further includes writing a third portion of the media file into the first buffer, reading out the second portion from the second buffer, converting the second portion, writing the second portion into a fourth buffer, reading out the first portion from the third buffer, and transferring the first portion to the media player.

### FIELD OF INVENTION

This invention relates to a method for downloading files from a computer network, through a computer, to a portable media player.

### DESCRIPTION OF RELATED ART

Portable media players allow users to take their digital media with them wherever they go. Typically the digital media is downloaded from the Internet onto a personal computer and then transferred from the personal computer to a portable media player (PMP). The personal computer may also convert the format of the media to one supported by the PMP. This is a time consuming process where the personal computer downloads the entire media file on the hard disk, retrieves and converts the media file to a new format, and then transfers the media file to the PMP. Thus, what is needed is a faster way to create media content for the PMP.

### BRIEF DESCRIPTION OF THE DRAWINGS

FIG. 1 illustrates a system for downloading media in one embodiment of the invention.

FIG. 2 illustrates a personal computer in the system of FIG. 1 in one embodiment of the invention.

FIG. 3 is a flowchart of a method for downloading media in one embodiment of the invention.

FIGS. 4 and 5 illustrate the method of FIG. 3 in one embodiment of the invention.

FIG. 6 is a flowchart of a method for downloading media in another embodiment of the invention.

FIG. 7 illustrates the method of FIG. 6 in one embodiment of the invention.

Use of the same reference numbers in different figures indicates similar or identical elements.

### SUMMARY

In one embodiment of the invention, a method for transferring a media file includes receiving the media file from a computer network and writing a first portion of the media file into a first buffer. When the first buffer is full, the method further includes writing a second portion of the media file into a second buffer, reading out the first portion from the first buffer, converting the first portion, and writing the first portion into a third buffer. When the second buffer is full and the first portion has been converted and written into the third buffer, the method further includes writing a third portion of the media file into the first buffer, reading out the second portion from the second buffer, converting the second portion, writing the second portion into a fourth buffer, reading out the first portion from the third buffer, and transferring the first portion to the media player. This process repeats until all the data in the media file is processed and transferred to the media player.

In another embodiment of the invention, a method for transferring a media file from a computer network to a media player includes receiving the media file from the computer network, writing a first portion of the media file into a first circular buffer at a location identified by a first write pointer, reading out a second portion of the media file from the first circular buffer at a location identified by a first read pointer, converting the second portion, writing the second portion into a second circular buffer at a location identified by a second write pointer; reading out a third portion of the media file from the second circular buffer at a location identified by a second read pointer, and transferring the third portion to the media player. This process repeats until all the data in the media file is processed and transferred to the media player. DETAILED DESCRIPTION

FIG. 1 illustrates a system 100 for a user to download a media file from a computer network (e.g., the Internet) 102 through a personal computer 104 and onto a portable media player (PMP) 106 in one embodiment of the invention. The media file is provided by a media provider through its website on computer network work 102. Computer 104 converts the media file to a format supported by PMP 106 before transferring the media file to PMP 106. The media file can be a music file, a video file, an image file, a text file, or a combination thereof.

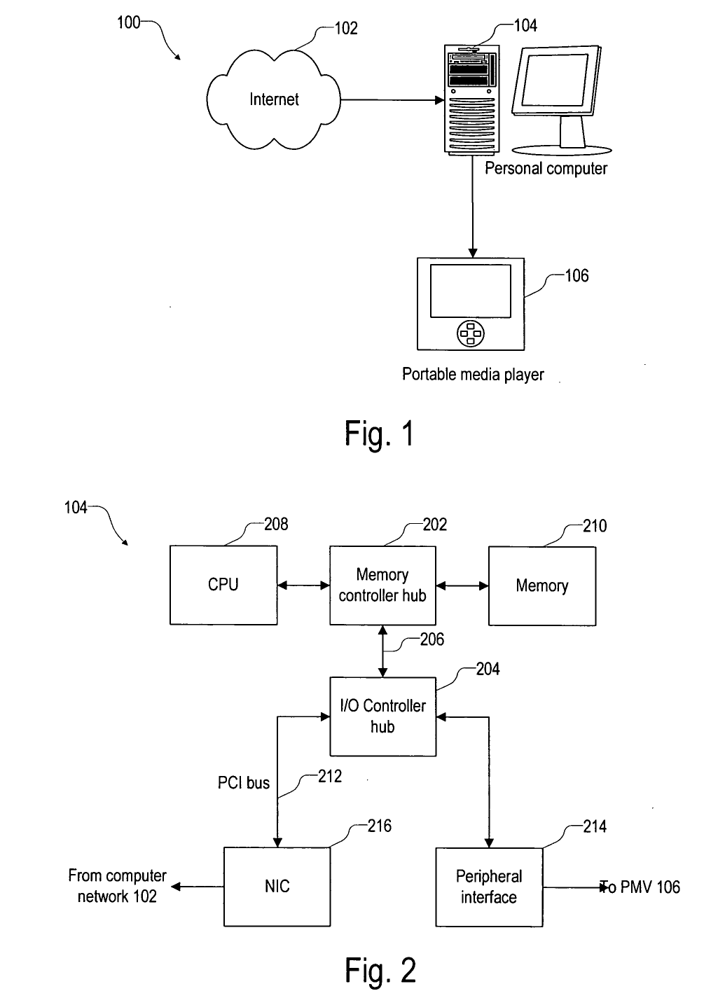

FIG. 2 illustrates the components of computer 104 in one embodiment of the invention. Computer 104 includes a memory controller hub (MCH) 202 that is connected to an I/O controller hub (ICH) 204 via a bus 206. MCH chip 202 provides the interface between a central processing unit (CPU) 208, memory 210, and ICH chip 204. ICH chip 204 provides the interface to a peripheral component interconnect (PCI) bus 212 and a peripheral interface 214. A network interface card (NIC) 216 is connected to PCI bus 212. Peripheral interface 214 is connected to PMP 106 while NIC 214 is coupled to computer network 102. Peripheral interface 214 can be a universal serial bus (USB) or an IEEE-1394 interface. NIC 216 can be an Ethernet card.

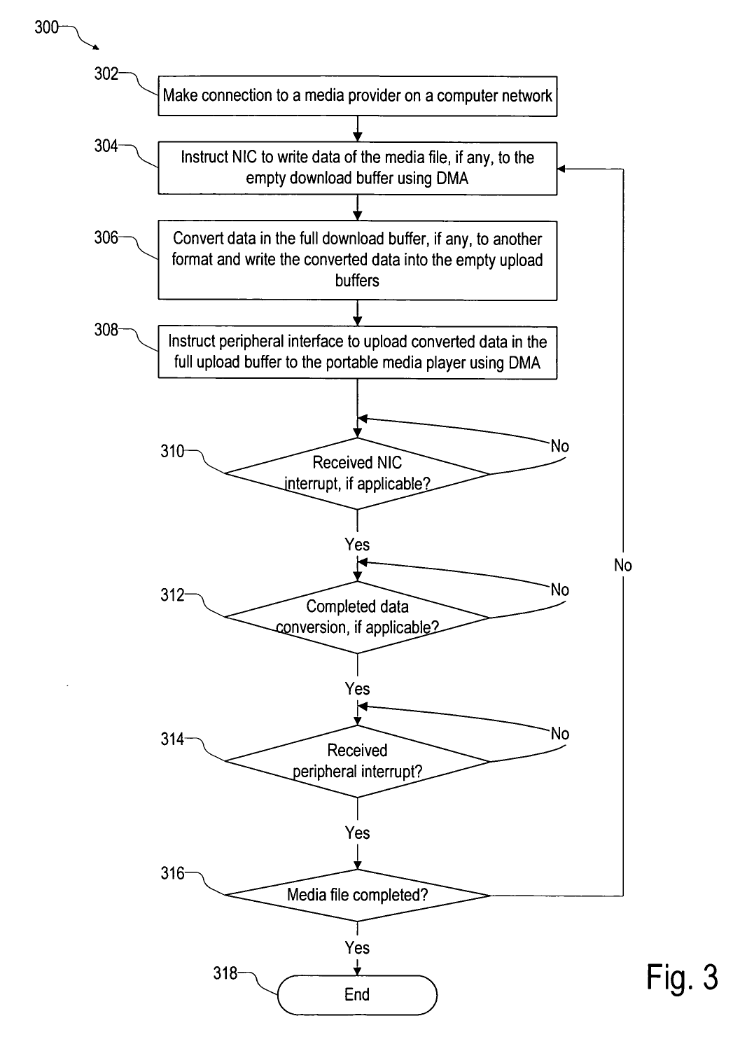

FIG. 3 is a flowchart of a method 300 for downloading a media file from computer network 102 through computer 104 and onto PMP 106 in one embodiment of the invention. Method 300 uses two download buffers and two transfer buffers in memory 210 of computer 104.

In step 302, CPU 208 uses NIC 216 to connect to a media provider on computer network 102 to download the media file.

In step 304, CPU 208 instructs NIC 216 to write a portion of the media file into an empty download buffer using direct memory access (DMA). The empty download buffer is selected from two download buffers which are both initially empty. In subsequent iterations through method 300, one will be empty while the other is filled with previously downloaded data. Note that in the last two iterations through method 300, there will be no remaining portion of the media file to write into the empty download buffer.

In step 306, CPU 208 reads a previously downloaded portion of the media file out of the full download buffer, if any, and converts it to a different format. CPU 208 then writes the converted portion into an empty transfer buffer. The empty transfer buffer is selected from two transfer buffers, which are both initially empty. In subsequent iterations through method 300, one will be empty while the other is filled with previously converted data. Note that in the last iteration through method 300, there will be no previously downloaded portion of the media file to convert and write into the empty transfer buffer.

In step 308, CPU 208 instructs peripheral interface 214 to transfer a previously converted portion of the media file from the full transfer buffer to PMP 106 using DMA.

In step 310, CPU 208 waits for an interrupt from NIC 216 to indicate that it has completed the write to the previously empty download buffer. If CPU 208 receives the interrupt, step 310 is followed by step 312. Otherwise step 310 loops until CPU 208 receives the interrupt. Note that in the last two iterations of method 300, step 310 is bypassed because there will be no remaining portion of the media file to write into the empty download buffer.

In step 312, CPU 208 determines if it has saved the converted data into the previously empty transfer buffer. If so, then step 312 is followed by step 314. Otherwise step 312 loops until CPU 208 has saved the converted data into the previously empty transfer buffer. Note that in the last iteration of method 300, step 312 is bypassed because there will be no previously downloaded portion of the media file to convert and write into the empty transfer buffer.

In step 314, CPU 208 waits for an interrupt from peripheral interface 214 to indicate that it has completed the transfer of the converted data from the previously full transfer buffer to PMP 106. If so, then step 314 is followed by step 316. Otherwise step 314 loops until peripheral interface 214 has transferred the converted data from the previously full transfer buffer to PMP 106.

In step 316, CPU 208 determines if the entire media file has been transferred to PMP 106. If so, then step 316 is followed by a step 318 that ends method 300. If the entire media file has not been transferred to PMP 106, then step 316 is followed by 304 and method 300 repeats until the media file is complete.

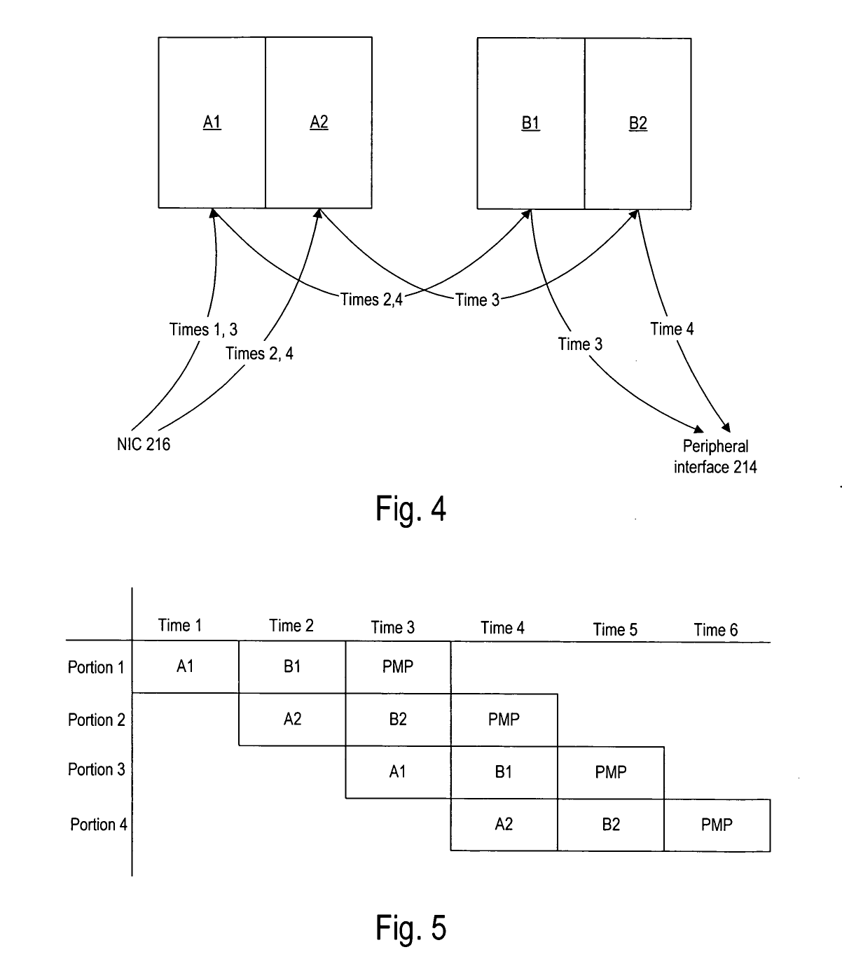

FIGS. 3 and 4 illustrate method 300 in one example where the media file is divided into 4 portions.

In time 1, portion 1 of the media file is written into an empty download buffer A1.

In time 2, portion 1 is read out of full download buffer A1, converted into a different format, and written into an empty transfer buffer B1. Portion 2 is written into an empty download buffer A2.

In time 3, portion 1 is read out of full transfer buffer B1 and transferred to PMP 106. Portion 2 is read out of full download buffer A2, converted into a different format, and written into an empty transfer buffer B2. Portion 3 is written into empty download buffer A1.

In time 4, portion 2 is read out of full transfer buffer B2 and transferred to PMP 106. Portion 3 is read out of full download buffer A1, converted into a different format, and written into empty transfer buffer B1. Portion 4 is written into empty download buffer A2.

In time 5, portion 3 is read out of full transfer buffer B1 and transferred to PMP 106. Portion 4 is read out of full download buffer A2, converted into a different format, and written into empty transfer buffer B2.

In time 6, portion 4 is read out of full transfer buffer B2 and transferred to PMP 106. Note that each of times 1 to 6 are limited by the slowest of three operations: (1) download from computer network 102 into a download buffer, (2) converting and saving the converted portion into a transfer buffer, and (3) transferring from a transfer buffer to PMP 106.

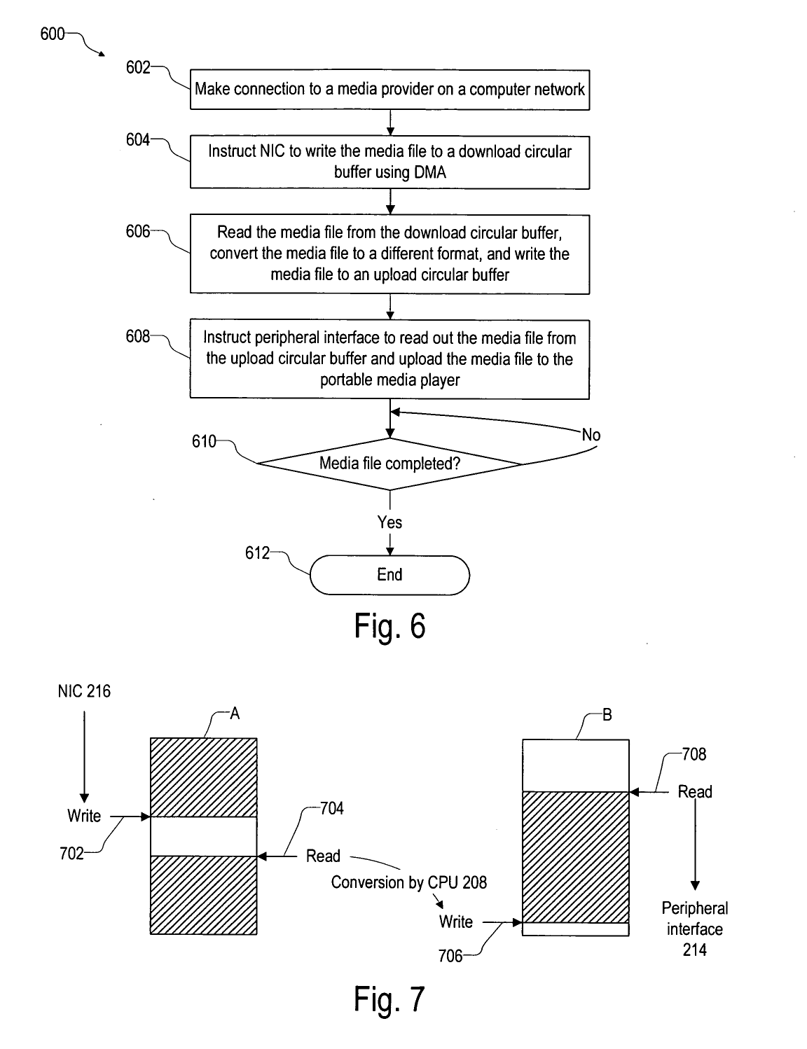

FIG. 6 is a flowchart of a method 600 for downloading a media file from computer network 102 through computer 104 and onto PMP 106 in another embodiment of the invention. Method 600 uses a download circular buffer and a transfer circular buffer in memory 210 of computer 104. A circular buffer is an area of memory used to store a continuous stream of data by starting again at the beginning of the buffer after reaching the end. Separate read and write pointers are maintained and they are not allowed to pass each other otherwise either unread data would be overwritten or invalid data would be read.

In step 602, CPU 208 uses NIC 216 to connect to a media provider on computer network 102 to download the media file.

In step 604, CPU 208 instructs NIC 216 to write the media file into the download circular buffer using DMA. NIC 216 writes the media file at a location specified by the write pointer of the download circular buffer.

In step 606, CPU 208 reads a previously downloaded portion of the media file out of the download circular buffer and converts it to a different format. CPU 208 reads the previously downloaded portion of the media file at a location specified by the read pointer of the download circular buffer. CPU 208 then writes the converted portion into the transfer circular buffer. CPU 208 writes the media file at a location specified by the write pointer of the transfer circular buffer.

In step 608, CPU 208 instructs peripheral interface 214 to transfer a previously converted portion of the media file from the transfer circular buffer to PMP 106 using DMA. Peripheral interface 214 reads the previously converted portion of the media file at a location specified by the read pointer of the transfer circular buffer.

In step 610, CPU 208 determines if the entire media file has been downloaded. If so, then step 610 is followed by step 612 that ends method 600. If the entire media file has not been downloaded, then step 610 loops until the media file is complete.

FIG. 7 illustrates method 600 in one example. As can be seen, the media file is written into a download circular buffer A at a location specified a write pointer 702. Previously downloaded portions of the media file is read from download circular buffer A at a location specified by a read pointer 704, converted into a different format, and written into a transfer circular buffer B at a location specified by a write pointer 706. Previously converted portions of the media file are read from transfer circular buffer B at a location specified by a read pointer 708 and transferred to PMP 106.

Various other adaptations and combinations of features of the embodiments disclosed are within the scope of the invention. Numerous embodiments are encompassed by the following claims.

What is claimed is:

1. A method for transferring a media file in a first format from a computer network to a media player, comprising:
receiving the media file from the computer network;
writing a first portion of the media file into a first buffer;
when the first buffer is full:
writing a second portion of the media file into a second buffer;
reading out the first portion from the first buffer, converting the first portion into a second format, and writing the first portion into a third buffer;
when the second buffer is full and the first portion has been converted and written into the third buffer:
writing a third portion of the media file into the first buffer;
reading out the second portion from the second buffer, converting the second portion into the second format and writing the second portion into a fourth buffer; and
reading out the first portion from the third buffer and transferring the first portion from the third buffer to the media player.

2. The method of claim 1, wherein said writing into the first and the second buffers comprises DMA operations by a network interface card.

3. The method of claim 1, wherein the transferring to the media player comprises a DMA operation by a peripheral interface.

4. The method of claim 1, further comprising:
when the first buffer is full, the second portion has been converted and written in the fourth buffer, and the first portion has been transferred to the media player:
writing a fourth portion of the media file into the second buffer;
reading out the third portion from the first buffer, converting the third portion into the second format, and writing the third portion into the third buffer; and
reading out the second portion from the fourth buffer and transferring the second portion to the media player.

5. A method for transferring a media file in a first format from a computer network to a media player, comprising:
receiving the media file from the computer network;
writing a first portion of the media file into a first circular buffer at a location identified by a first write pointer;
reading out a second portion of the media file from the first circular buffer at a location identified by a first read pointer, converting the second portion into a second format, and writing the second portion into a second circular buffer at a location identified by a second write pointer; and
reading out a third portion of the media file from the second circular buffer at a location identified by a second read pointer and transferring the third portion to the media player.

6. The method of claim 1, wherein the writing into the first circular buffer comprises a DMA operation by a network interface card.

7. The method of claim 1, wherein the transferring the media file to the media player comprises a DMA operation by a peripheral interface.
